(19) United States
(12) Patent Application Publication
(10) Pub. No.: US 2020/0400118 A1
(43) Pub. Date: Dec. 24, 2020

(54) Paddlewheel Generator

(71) Applicant: Michael John Tedaldi, Hicksville, NY (US)

(72) Inventor: Michael John Tedaldi, Hicksville, NY (US)

(21) Appl. No.: 16/875,264

(22) Filed: May 15, 2020

Related U.S. Application Data
(60) Provisional application No. 62/864,499, filed on Jun. 20, 2019.
(60) Provisional application No. 62/864,575, filed on Jun. 21, 2019.

(51) Int. Cl. F03D 3/00; F03D 7/06

(52) U.S. Cl. CPC F03D 3/002; F03D 7/06

(57) ABSTRACT

The Paddlewheel Generator is a horizontal rooftop device used to transform wind energy into electrical energy. It accomplishes this utilizing a one of a kind modular paddlewheel section encased in a modular enclosure section. The modular paddlewheel is made strong enough to withstand adverse local weather conditions. The Paddlewheel module is encased in a distinctive modular enclosure, customizable to the local building codes for safety and finished to enhance its aesthetic environment. The Paddlewheel Generator is uniquely designed to be compatible with other sustainable energy sources, versatile enough to satisfy a wide range of power requirements.

### BACKGROUND OF THE INVENTION

I became interested in renewable energy and looked into a solar installation for my residence. I contacted a local firm and they visited my home and made a site evaluation. Unfortunately my neighbor's two very large maple trees were so situated as to create enough shadow on my roof to preclude the feasibility of a solar installation. In 2010 I began to consider another option and started to gather information for what would ultimately become my Paddlewheel Project.

The likely candidate for a renewable energy source was wind power. Upon investigating different systems, I found they were all of similar construction. They were turbines seated on tall poles. This presented a problem for two reasons. Esthetically, they did not fit into the architecture of my residence or neighborhood. They simply looked out of place. Secondly, because of their structure, they cause, a perceived, if not real, safety concern. We are subject to hurricanes and the tall pole with a heavy top mass required a considerable engineering solution. There were also concerns with town rules and approvals. For all these reasons, I did not choose any presently available residential wind solution.

After some consideration, I came up with a solution that was horizontal in nature, was structurally safe, and would provide electric power other wind systems were providing for residences. A paddlewheel device could be provided, on the top of a home or garage roof, to catch the winds energy. It could be housed in a structure that would complement the roof line of the home, garage or other such structure, thus presenting an esthetic improvement to the facility rather than an eyesore. FIG. 1 in the drawing section is an example of how the Paddlewheel Generator could be added to a two-car garage, enhancing its esthetic look while providing continuous electrical power.

### BRIEF SUMMARY OF THE INVENTION

The Paddlewheel Generator is a utilitarian device that collects wind energy and transforms it into electrical energy that powers essential applications. Essential applications may include; heating systems, refrigerators, health apparatus, automobile charging stations and other applications as designated by the facility owner and as power from the Paddlewheel Generator is available. Its grid independence provides the facility owner with a safety net when grid power blackouts occur.

The Paddlewheel Generator housing is set atop an existing structure, such as a garage or main residence. It is intended to be esthetically compatible with the existing structure. FIG. 1, in the drawing section, illustrates this esthetic harmony.

In order to blend with its environment, it will be made of much the same decretive material as the existing structure. The paddlewheel itself is intended to be made of a light structurally strong material like aluminum or carbon fiber.

The Paddlewheel Generator gathers wind energy using a paddlewheel and is located inside the Paddlewheel Generator housing. The paddlewheel's rotating axis is perpendicular to the direction of the wind. The Paddlewheel Generator may provide continuous power to the essential applications by storing that energy in a battery system.

The Paddlewheel Generator is designed to be a stand alone system or part of a system of power sources such as the grid, solar or water power.

### CROSS REFERENCE OF RELATED APPLICATIONS

The Paddlewheel Generator is consistent with the following Classification:
Classification Scheme Y02E 10/74: Reduction of Greenhouse Gas Emissions Related to Wind Energy turbines with rotational axis perpendicular to the wind direction

### STATEMENT REGARDING FED SPONSORED R & D

Energy Information Administration's Regional Energy Profile, U.S. Household Electricity Report, release date: Jul. 14, 2005, was used for the electricity consumption by 107 million U.S. households in 2001

US Department of Commerce, National Oceanic and Atmospheric Administration, National Climatic Data Center, Average US Wind Speed in Miles per Hour, http://www.ncdc.noaa.gov/oa/climate/online/ccd/avgwind.html, Last Updated Wednesday, 20 Aug. 2008 12:21:34 EDT was used for average wind velocity numbers.

### DESCRIPTION OF FIGURES OF THE DRAWINGS

FIG. 1: The drawing represents a typical installation of the Paddlewheel Generator. It highlights its unique horizontal orientation, merging esthetically with its supporting structure.

FIG. 2: This drawing is a look at the structure of a paddlewheel section itself.

FIG. 3: The drawing shows the major components of the Paddlewheel Generator in a typical housing.

FIG. 4: The drawing is a block diagram of a typical Paddlewheel Generator system, incorporating operating options such as additional solar input and grid transfer.

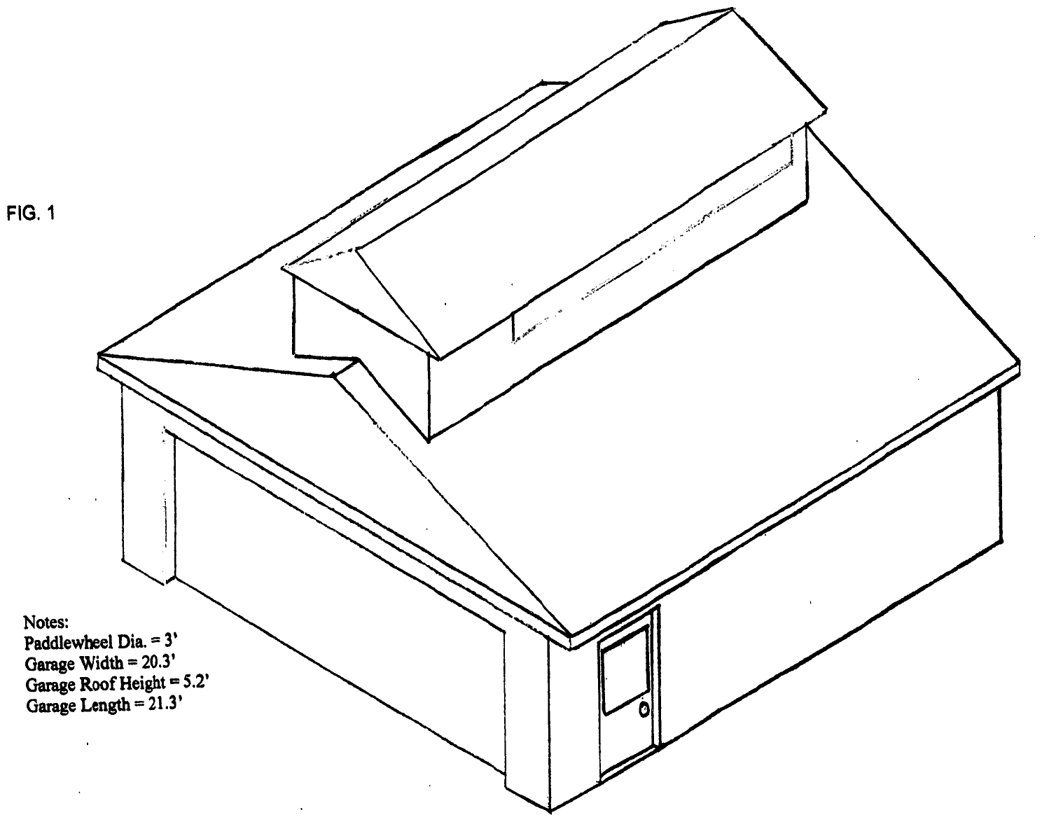

### FEATURE DESCRIPTION

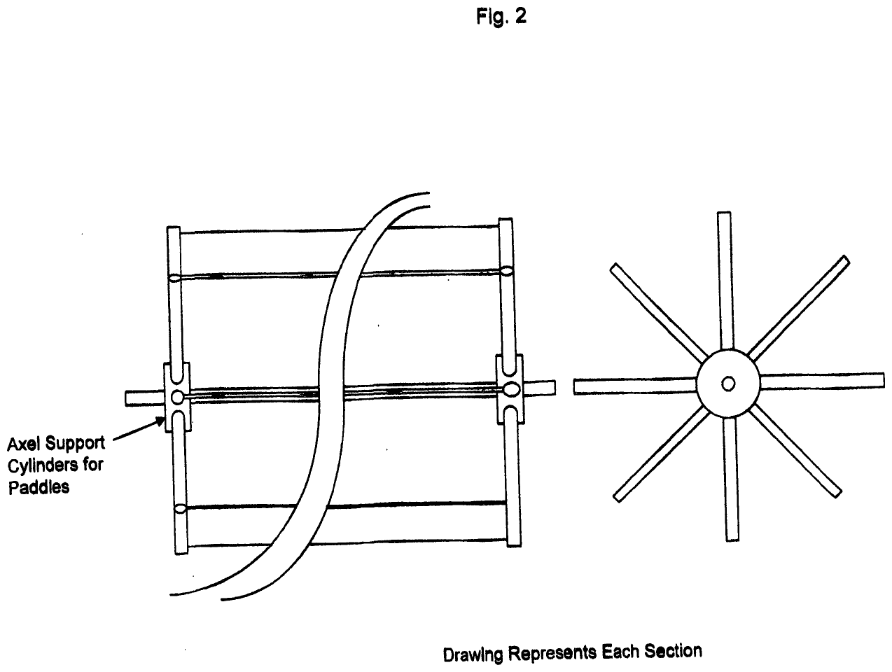

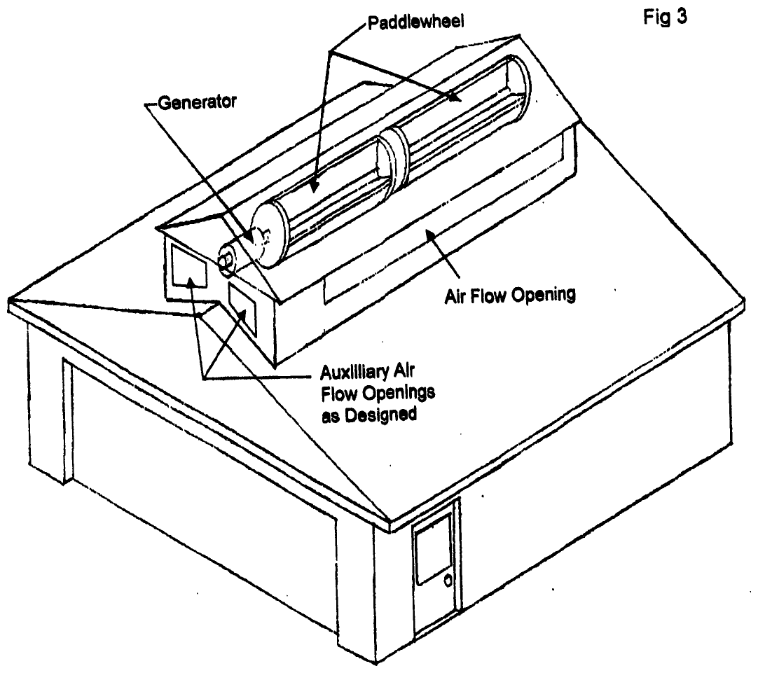

The Paddlewheel Generator's paddlewheel is central to the system in which the invention operates. Its paddles are wide, going from the top of the paddlewheel to its axis of rotation. The paddlewheel is long, covering almost the entire length of the installed location. Both its width and elongation are maximized to gather as much wing energy as available. FIG. 2, in the drawing section, illustrates the construction details of the paddlewheel itself. The paddlewheel will be made in two sections, each section approximately half the length of the installation. Each section will be connected to a generator, either directly or belt driven.

Openings in the structure allow air flow to turn the paddlewheel. Because the paddlewheel is a static installation, the largest of these openings faces the direction of the predominant wind in the area. Additional openings may be provided to capitalize on other wind direction as dictated by the site location.

FIG. 3, in the drawing section, illustrates the orientation of the paddlewheel's major components.

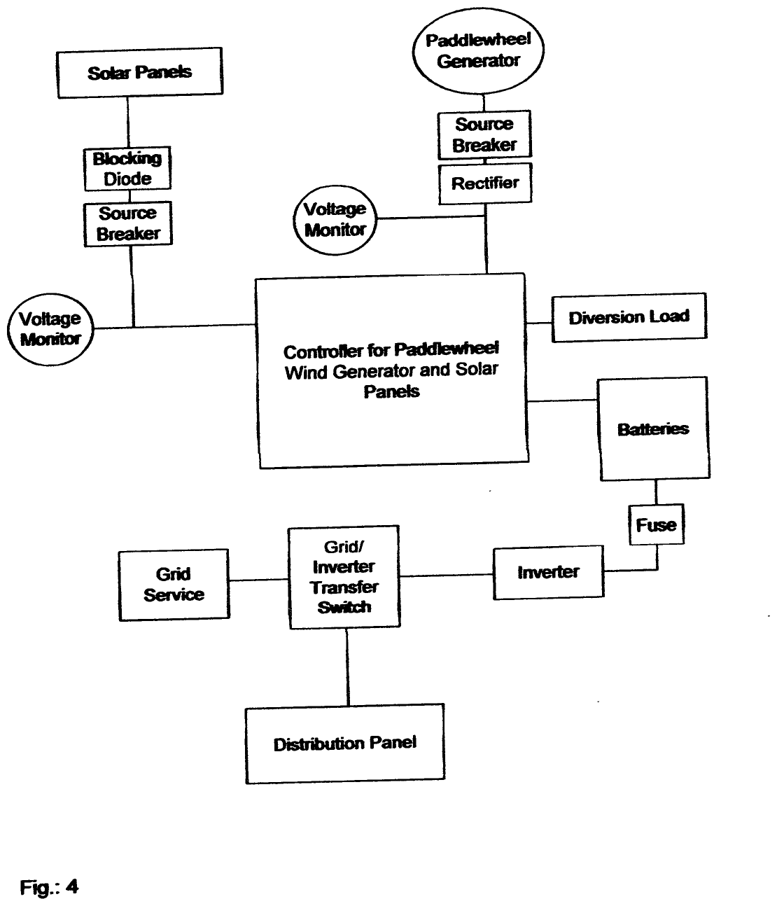

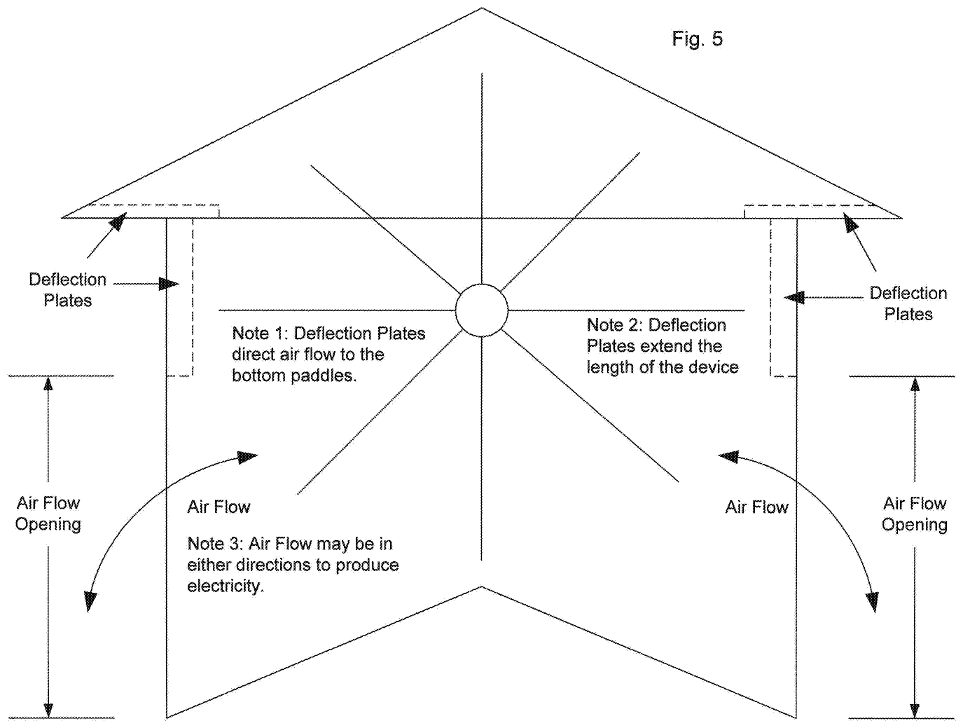

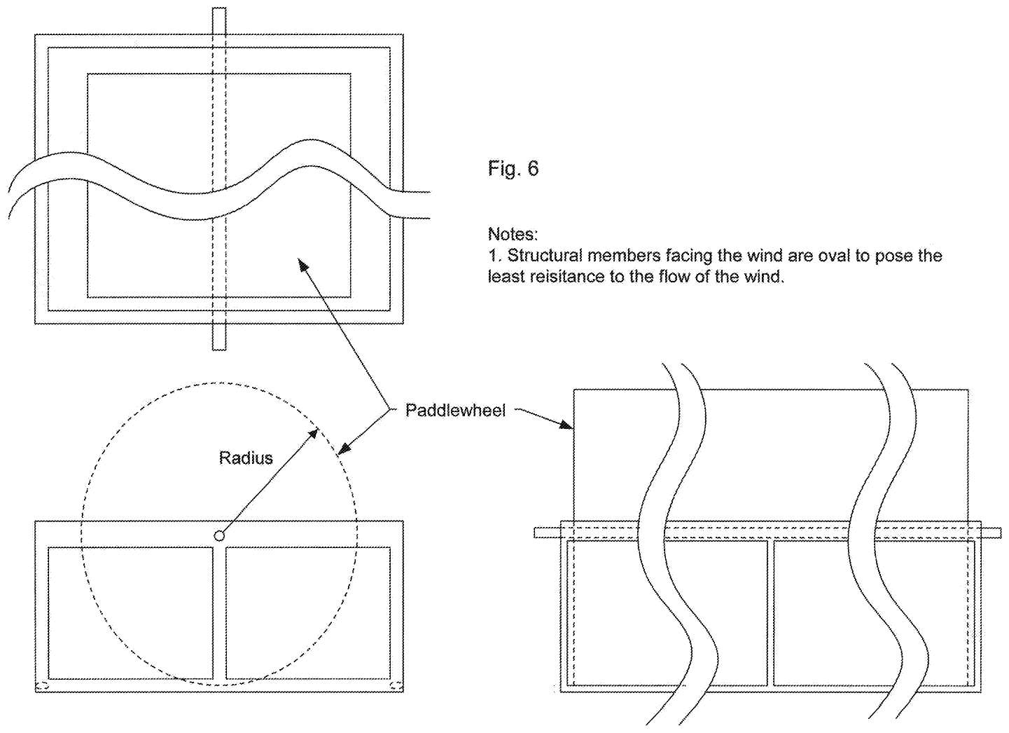

The Paddlewheel Generator will utilize a controller. The controller brings the components of the system together. The system may be designed to capture multiple energy sources. For example, electrical energy from solar panels and the Paddlewheel Generator may be fed into the controller. Voltage from both sources will be monitored by the controller. Over current protection will protect the controller. A blocking diode may be used to assure that reverse polarity voltage is not fed back into the solar panels. A rectifier will assure that wind generator voltage polarity is of a consistent polarity at the controller terminals. A diversion load may be used to shunt voltage energy surges (created by the wind generator) away from the controller. The controller will charge the battery pack designed to store the recovered energy. The battery is connected, by way of an overprotection device, to an inverter. The inverter changes the DC voltage to an AC voltage, used for power. The inverter is connected to a distribution panel that might power refrigerators, heating systems (gas, oil or geothermal), car charging station, etc. FIG. 4 in the drawing section is a block diagram of a typical Paddlewheel Generator system.

Ideally the paddlewheel sections will be a carbon fiber construction. Keeping it lightweight and structurally sound are critical. The lighter the Paddlewheel Generator is, the more energy it can take from the wind and transform to electrical power. The paddlewheel will need to be strong enough to sustain hurricane winds. Because of cost considerations, aluminum may be used, also because it is lightweight and strong.

Housing for the Paddlewheel Generator will be made of materials consistent with the structure it sits upon. Typically, a wood frame or carbon fiber construction topped with a roof and sided in accordance with the esthetics of the facility. Panels in the construction will allow for access to parts of the Paddlewheel Generator that might be needed for installation or future maintenance or rePair.

Based on details of the rooftop location, the Paddlewheel Generator will be constructed offsite. This will include the paddlewheel, generator and housing. The unit will be large and will need to be trucked to the site. A crane will be used to place the Paddlewheel Generator on the site roof. A licensed electrician will connect all the components of the system, including the controller,

1 The Paddlewheel Generator is a unique wind energy gathering turbine device because its customizable horizontal enclosure allows it to be in aesthetic harmony with many different architectural environments.

2 Its modular construction makes the Paddlewheel Generator unique and facilitates cost effective production and installation.

3 The Paddlewheels modular paddlewheel sections and direct current output allow multiple combinations to uniquely fit many different field applications.

4 Because of its high strength modular sections and the enclosure's designability to local construction code requirements, the Paddlewheel Generator is uniquely prepared to survive the harshest weather conditions.
